(19) United States
(12) Patent Application Publication
(10) Pub. No.: US 2019/0059202 A1
(43) Pub. Date: Feb. 28, 2019

(54) Artificial Intelligence System for In-Vivo, Real-Time Agriculture Optimization Driven by Low-Cost, Persistent Measurement of Plant-Light Interactions

(71) Applicant: Michael C. Lorek, Sacramento, CA (US)

(72) Inventor: Michael C. Lorek, Sacramento, CA (US)

(21) Appl. No.: 16/057,811

(22) Filed: Aug. 7, 2018

Related U.S. Application Data
(60) Provisional application No. 62/542,261, filed on Aug. 7, 2017.

(51) Int. Cl. A01B 79/00; G06Q 50/02; G06Q 10/04; G06Q 10/06; A01G 25/16

(52) U.S. Cl. CPC A01B 79/005; G06Q 50/02; A01G 25/167; G06Q 10/0631; G06Q 10/04

(57) ABSTRACT

Herein is described an electronic sensor and Artificial Intelligence (AI) system capable of optimizing agriculture processes in real-time. A number of wired or wireless optical, electrical, thermal, chemical, biological, or other sensors are deployed in a plant's locality, possibly for its full lifecycle. These sensors provide long-term, in vivo observations of both the plant's environment and the plant itself. A plant's interaction with light is measured by persistent, cloud-connected sensors, including a spectral reflectance sensor, Chlorophyll Fluorescence detector (ChFl), ChFl imager, and a near-IR imager. This sensor data enables the in-vivo characterization of a plant's health status and photosynthetic efficiency. A cloud-powered AI system uses machine learning algorithms to model the system, recommend agricultural process improvements, and identify abnormalities associated with plant disease or pests. As the invention gets enough sensor data across various environmental conditions, an ideal target process flow can be identified for a given plant genotype, phenotype, or other additional specificity.

### CROSS REFERENCE TO RELATED APPLICATIONS

The present invention claims the benefit of, priority to, and incorporates by reference, in its entirety, the follow provisional patent applications under 35 U.S.C. Section 119(e): 62/542,261, entitled SENSOR FUSION SYSTEM FOR IN VIVO ESTIMATION OF PLANT HEALTH STATUS AND REAL-TIME AGRICULTURAL PROCESS OPTIMIZATION filed Aug. 7, 2017.

### FIELD OF INVENTION

The present invention is directed to a method, system, and apparatus for an in vivo estimation of plant health status and a responsive real-time agricultural process optimization using one or more sensors.

### DISCUSSION OF THE BACKGROUND

In some agricultural markets, processes for growing first-rate crops are based on knowledge gained through many years of experience. The optimization of these processes typically requires numerous months-long trial-and-error cycles, often carried out with limited scientific documentation and analysis. This leads to long periods of process optimization for new farmers, and, even for experienced farmers attempting to grow plants of new genotypes or phenotypes.

Herein is described an electronic sensor solution capable of optimizing agriculture processes in real-time. A number of wired or wireless optical, electrical, thermal, chemical, biological, or other sensors are deployed in a plant's locality, possibly for its full lifecycle. The sensors can be placed at any desired density throughout the farm, including on every plant. The system can be deployed on plants in various growing media, including soil and water. These sensors provide long-term, in vivo observations of both the plant's environment and the plant itself.

Using a set of these measurements, computer algorithms can be used to estimate the plant's health status. Machine learning can be used to continuously improve models and algorithms based on new sensor data. Additional algorithms can identify process flow modifications that are expected to optimize a desired crop trait. As measurements are obtained across a range of conditions, an ideal target process recipe can be determined for a specific plant's genotype, phenotype, and desired trait of optimization. Farmers can also provide the software algorithms with post-harvest measurements acquired later in the processing flow, such as yield, quality, or chemical makeup. This enables the further tuning of software algorithms and models based on final deliverables for improved farming performance.

Farmers can view the state of their system, sensor data, and other calculated parameters in near real-time on an internet connected device, such as a cellular phone app, internet browser, PC application, or other. The farmer can also view plots of historical data. The system is adaptable to various farming and control system setups to provide farmers with suggested changes that they can implement. The sensor system can also be interfaced with a farm's lighting, nutrient, watering, environment, or other control systems for automated closed-loop feedback and real-time optimization.

A basestation serves as a central hub, with: power supply and management circuitry, digital and/or analog signal processing, computing unit (e.g. microcontroller, system on chip, CPU, single-board computer, other), digital bus (e.g. SPI, I²C, other), wired analog/digital connections to various sensors/stimulus, and an RF wireless communication interface. The basestation is capable of powering and communicating with its various sensing/stimulus subunits over analog or digital links. The basestation aggregates sensor data, performs signal processing, and transmits the data to a server for potential further analysis. Sensor data can be transmitted via an 802.15.4, 802.11, Bluetooth, or other wireless communication protocol. The sensor nodes can be connected directly to a network gateway or form a mesh network to transmit data between multiple sensor nodes before the data reaches a gateway.

The electronic systems can be built on printed circuit boards, on an integrated circuit, or other surface mount electrical circuit fabrication technology. The system can be powered by AC power, a battery, a solar cell, or another energy harvesting technology. Sensor/stimulus subsystems can also include a local analog-digital converter for better resilience to environmental noise. Wired connections between the basestation and other subsystems can be shielded, e.g. using a coaxial cable, for better resilience to environmental noise.

A set of the following sensors can be used for monitoring the health and status of a plant, in vivo. The sensor outputs can be analog or digital in nature. Additional sensors may be added to complement what is listed below. Some of these individual sensors could be placed in different subsystems than what is described here. Various types of spectrometers can be used for optical spectrum sensing, including but not limited to: diffraction grating-based, semiconductor image sensor+nano optical filter array, or an array of off-the-shelf LEDs (used in sensing mode), photodiodes, phototransistors or photoresistors. A soil subunit may include one or more sensors for assessing soil pH; soil electrical conductivity; soil suspended solids; soil real and imaginary electrical impedances at various frequencies. A leaf subunit may include one or more sensors including visible range optical spectrometer; an infrared temperature sensor (remote temperature sensing); a local temperature sensor; a hygrometer; a proximity sensor; and a microphone. A flower or fruit subunit may include one or more of visible range optical spectrometer; an infrared range optical spectrometer; an infrared temperature sensor (remote temperature sensing); a local temperature sensor; a proximity sensor; and a microphone. An incident light sensor subunit may include one or more of the following a visible range optical spectrometer; an ultraviolet range optical spectrometer; an infrared temperature sensor (remote temperature sensing); a local temperature sensor; a proximity sensor; a photodiode/photoresistor/phototransistor supporting signal bandwidth up to approximately 100 kHz-1 MHz. The basestation subsystem would include one or more of the following: a CO2 sensor, a Volatile Organic Compound (VOC) sensor, an airborne particulate matter sensor, a pressure sensor; a Hygrometer; a sensor to measure electric potential difference across various points in plant structure; and multiple electrodes throughout root network, attached via conductive interface to measure plant's internal, e.g. xylem, or external electric potential at multiple points spanning plant height; and a microphone.

The invention may use an optical stimulus subsystem to capture the effect of Chlorophyll Fluorescence (ChFl). This subunit provides the capability to stimulate the plant optically with various wavelengths of light. During the optical stimulus, the response of the various other sensors can be monitored simultaneously. Stimulus LEDs include one or more of blue, green, white, yellow LEDs; near-infrared LED; and Ultraviolet LED

The invention may use an acoustic stimulus subsystem. This subsystem can include the capability to produce sounds with the intent of influencing plant behavior. One manifestation of the subsystem can include a speaker, oscillator (e.g. relaxation oscillator, LC oscillator, voltage-controlled oscillator), microcontroller, analog signal processing, digital signal processing, high-current speaker driver circuit, variable resistor, resistor bank, and/or others. Sound waves of various frequencies and intensities can be emitted towards the plant by a speaker, while the system simultaneously monitoring the response of other sensors.

The invention may use a thermal stimulus subsystem. In addition to sensors that measure the leaf, flower/fruit, and canopy temperatures, electrical-to-thermal energy transducers can be installed in a plant's locality to help regulate its microclimate. A resistor can be used as a thermal energy dissipator. A thermoelectric device can also be used to pump heat energy either towards or away (cooling) from a plant. This can be used to help create the ideal microclimate a plant desires. The thermoelectric device can also potentially be used as an energy harvester for powering other electronics.

The invention may be optimized using big data analysis and machine learning. This processing can happen at either a sensor system's local basestation, at a remote computing server, or both. The optimization may include persistent electronic sensing of many of the plant's environmental characteristics, e.g. soil moisture, soil pH, relative humidity, soil nutrients, pressure, canopy temperature, lighting spectrum, lighting intensity, CO2 levels, Chlorophyll Fluorescence, and others. Those aggregated measurements would correlate to the health status by examination of the chemical, biological, electrical, optical, biochemical, thermal, or other parameters. The algorithms can also be non-physical-based, generated by behavioral observations, or a combination of all of the above. Machine learning algorithms can evolve models by monitoring many of the plant's observables, e.g. leaf temperature, flower temperature, leaf optical spectrum, flower optical spectrum, hydration status, and others. This enables the system and method to be improved in real-time, as the plant's response to changes in environmental conditions is observed. The algorithms can simultaneously process sensor data from many installations across many locations to improve optimization.

The data can also be used to model and predict agricultural process changes that are expected to improve a desired outcome. A desired outcome can include a plant's weight, quality, color, chemical makeup, among others. As these process changes are made, known data can be used to further improve the models. As the invention gets enough sensor data across various environmental conditions, an ideal target process flow can be identified for a given plant genotype, phenotype, or other additional specificity. A database of ideal recipes for various types of plants and desired optimization outcomes can be maintained and updated continuously.

### BRIEF DESCRIPTION OF THE DRAWINGS

The following description, given with respect to the attached drawings, may be better understood with reference to the non-limiting examples of the drawings, wherein:

The following description, given with respect to the attached drawings, may be better understood with reference to the non-limiting examples of the drawings, wherein:

FIG. 1 is an exemplary plant in a planter with soil. The plant has roots, stem, leaves, and flowers or fruit.

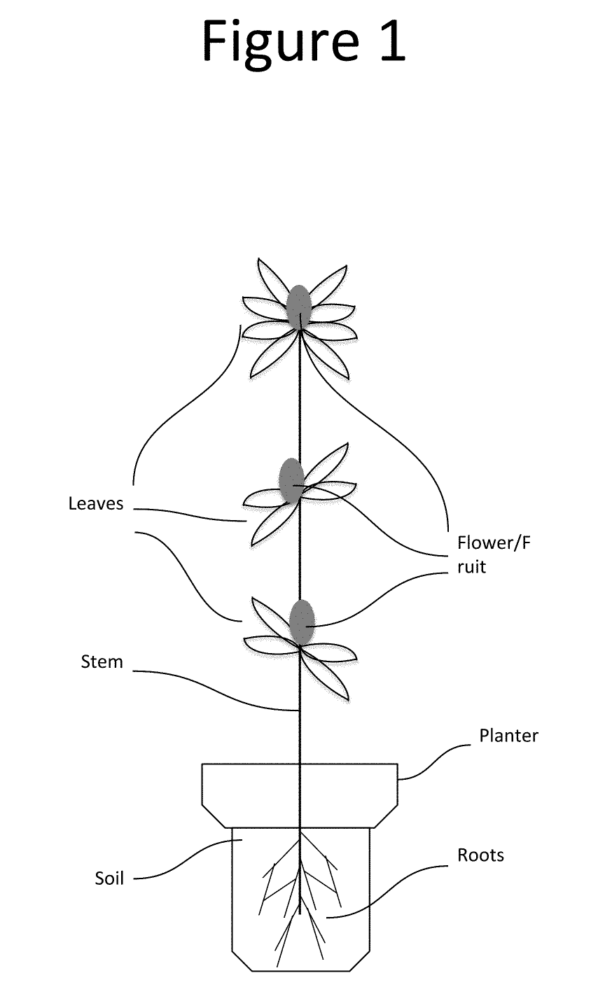

FIG. 2 shows an exemplary electronic system installed on a plant in a planter. Electrical conductors connect a basestation to multiple subsystems for sensing and optical stimulus. Flower/fruit and leaf subsystems are positioned close to and facing their respective targets. The system can be supported mechanically by rigid cabling as shown, or by stakes into the planter, support to another nearby structure, or other method.

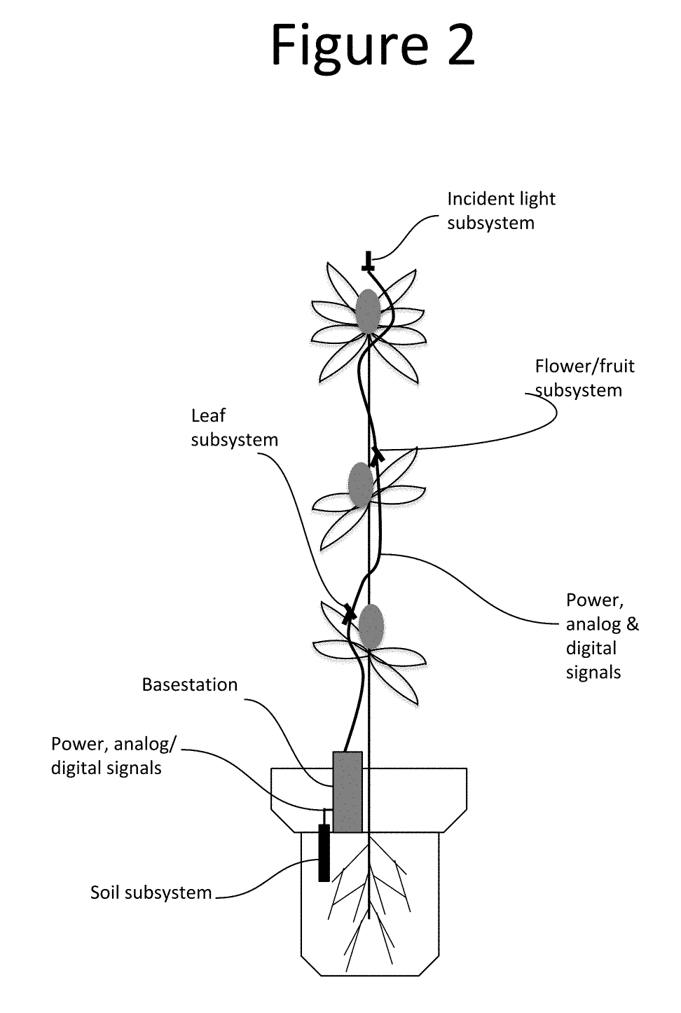

FIG. 3 is an exemplary plant that is planted outdoors in soil. The plant has roots, stem, leaves, and flowers or fruit.

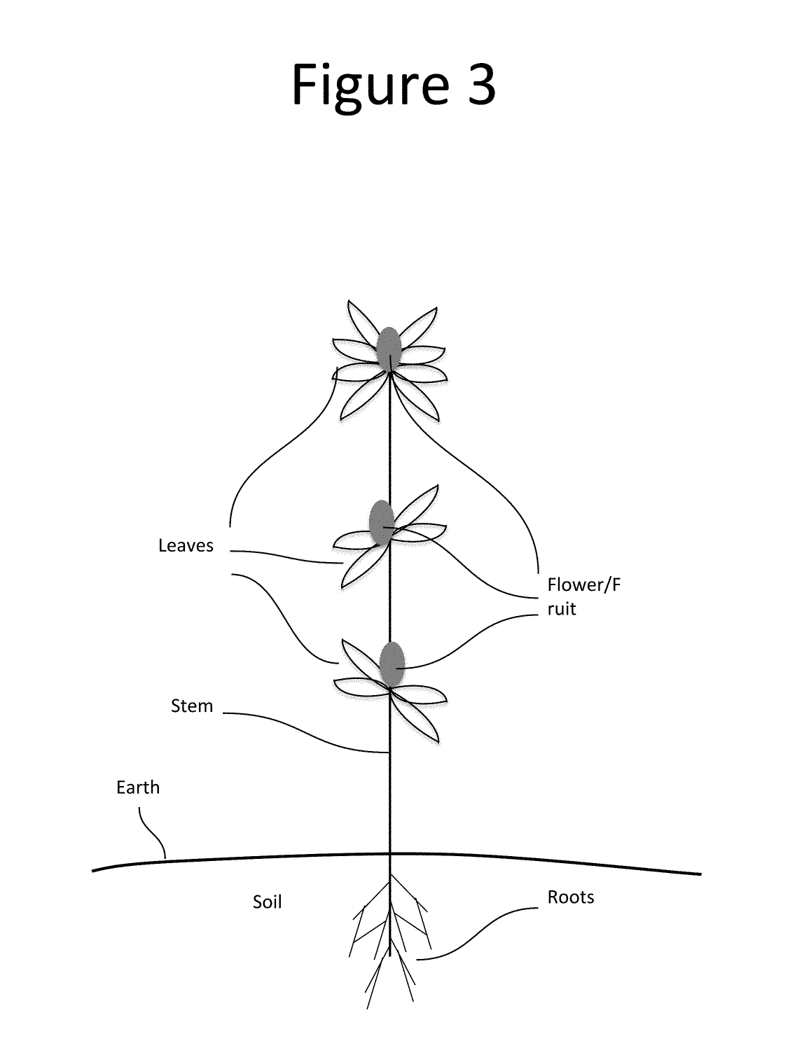

FIG. 4 is an electronic system installed on a plant in soil outdoors. Electrical conductors connect a basestation to multiple subsystems for sensing and stimulus. Flower/fruit and leaf subsystems are positioned facing their respective targets. The system can be supported mechanically by rigid cabling as shown, or by stakes into the planter, support to another nearby structure, or other method.

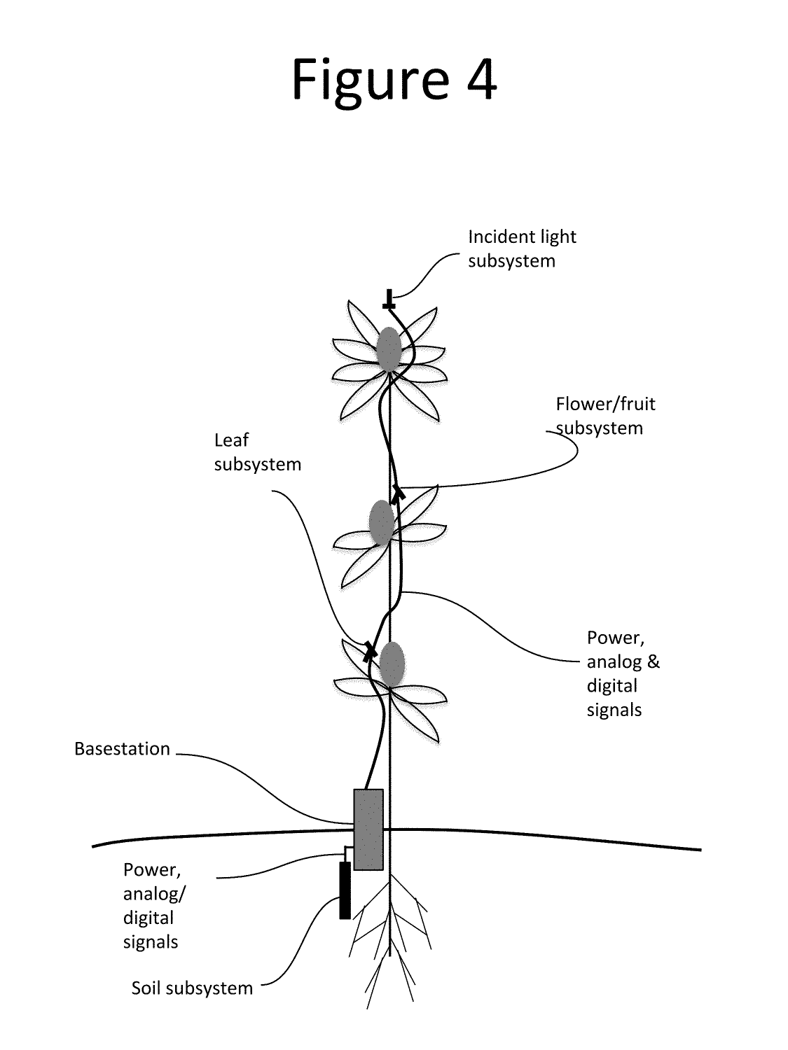

FIG. 5 is an exemplary plant in a hydroponic farming setup. The plant has roots, stem, leaves, and flowers or fruit. Water and nutrients are supplied continuously to the plant's roots. A growing medium may or may not be used. A frame or scaffolding structure exists in the plant's vicinity.

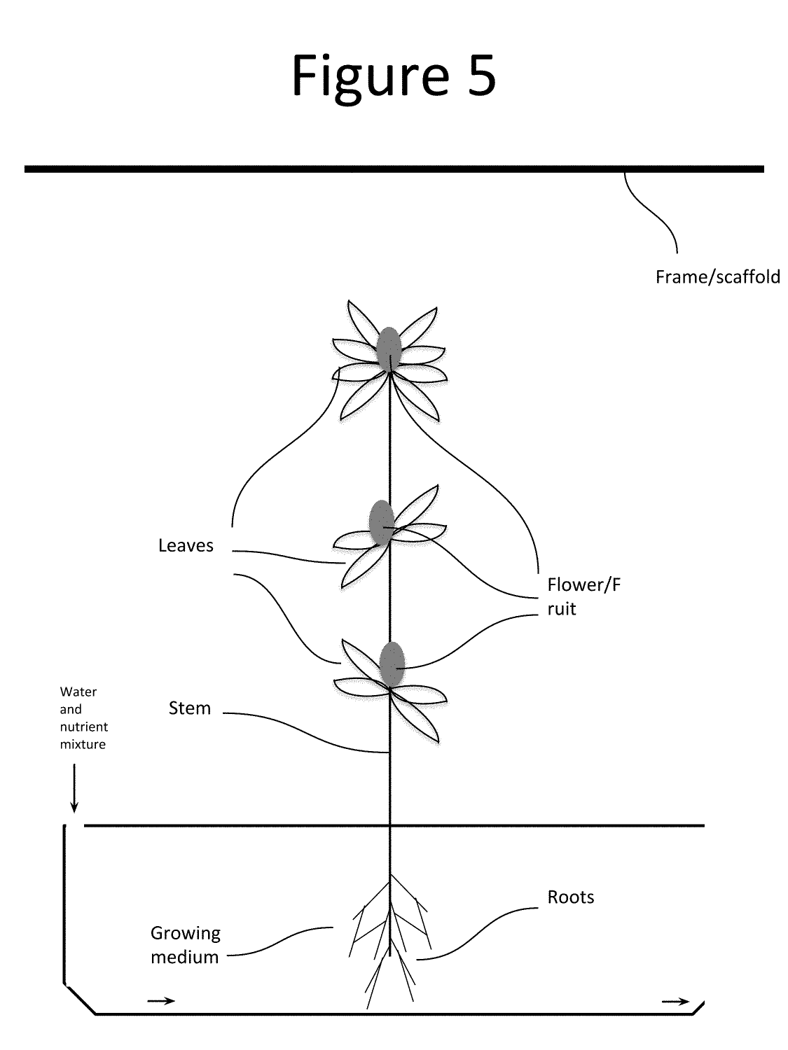

FIG. 6 is an exemplary electronic system installed on a plant in a hydroponic farming setup. Electrical conductors connect a basestation to multiple subsystems for sensing and stimulus. Flower/fruit and leaf subsystems are positioned close to and facing their respective targets. A frame or scaffolding structure exists in the plant's vicinity. The electronic system is supported mechanically from the frame/scaffolding.

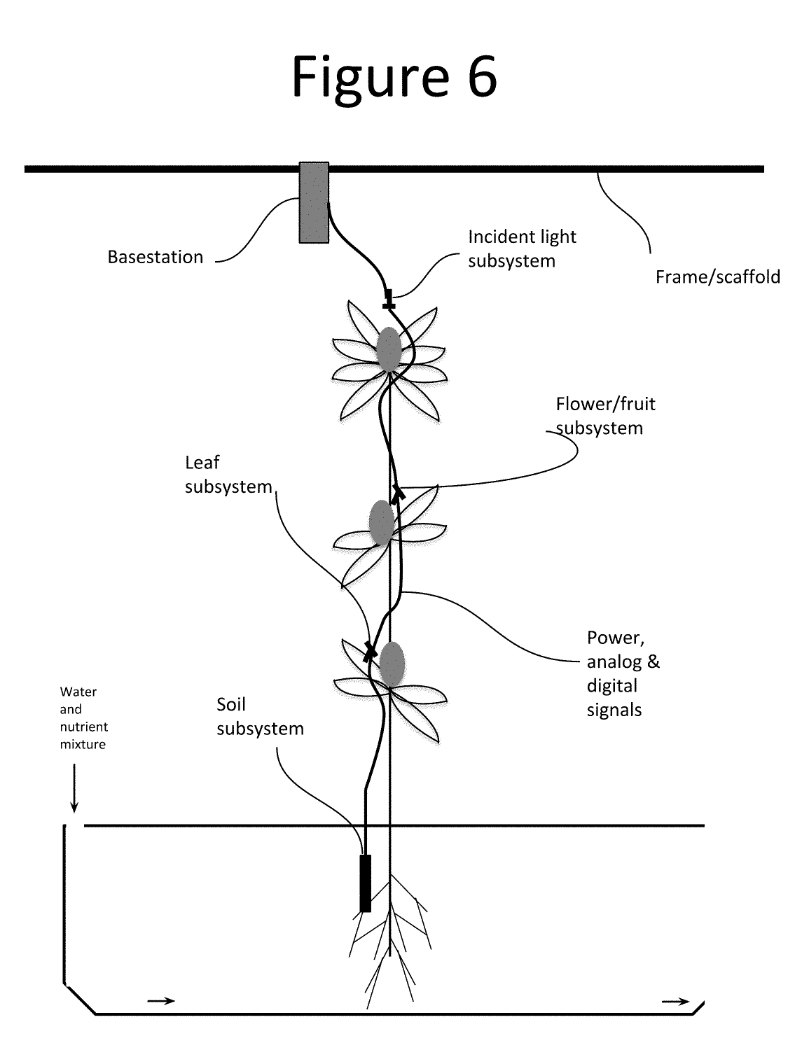

FIG. 7 shows one manifestation of a leaf subsystem housing. The housing is a hollow cylinder. The leaf passes through the center opening of the cylindrical housing, and one or more leaf electronic subunits observe the leaf. Other shapes besides a cylinder could be used. A similar manifestation could also be used for the flower/fruit subsystem. The housing can be supported mechanically by rigid cabling, by stakes into soil stakes into soil, by support to another nearby structure, or other method.

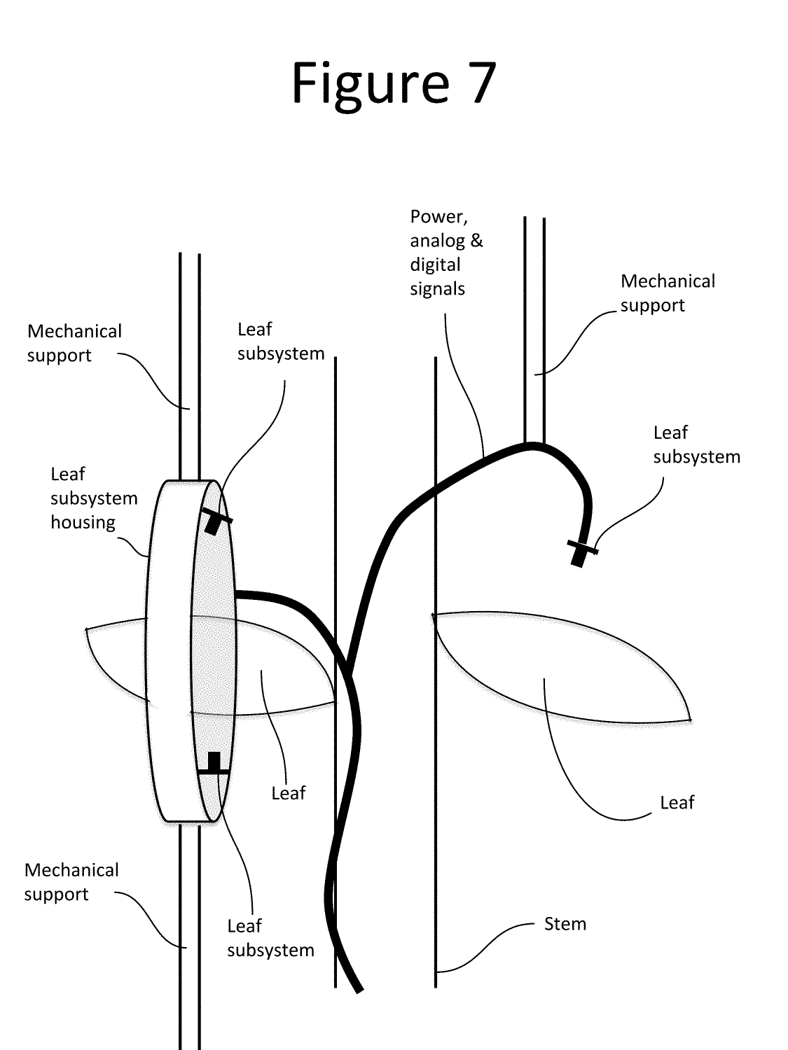

FIG. 8 is an exemplary persistent spectral reflectance sensor installation. Two spectrometers measure both the incident and reflected spectra and communicate with a single-board computer to calculate the reflectance of the plant.

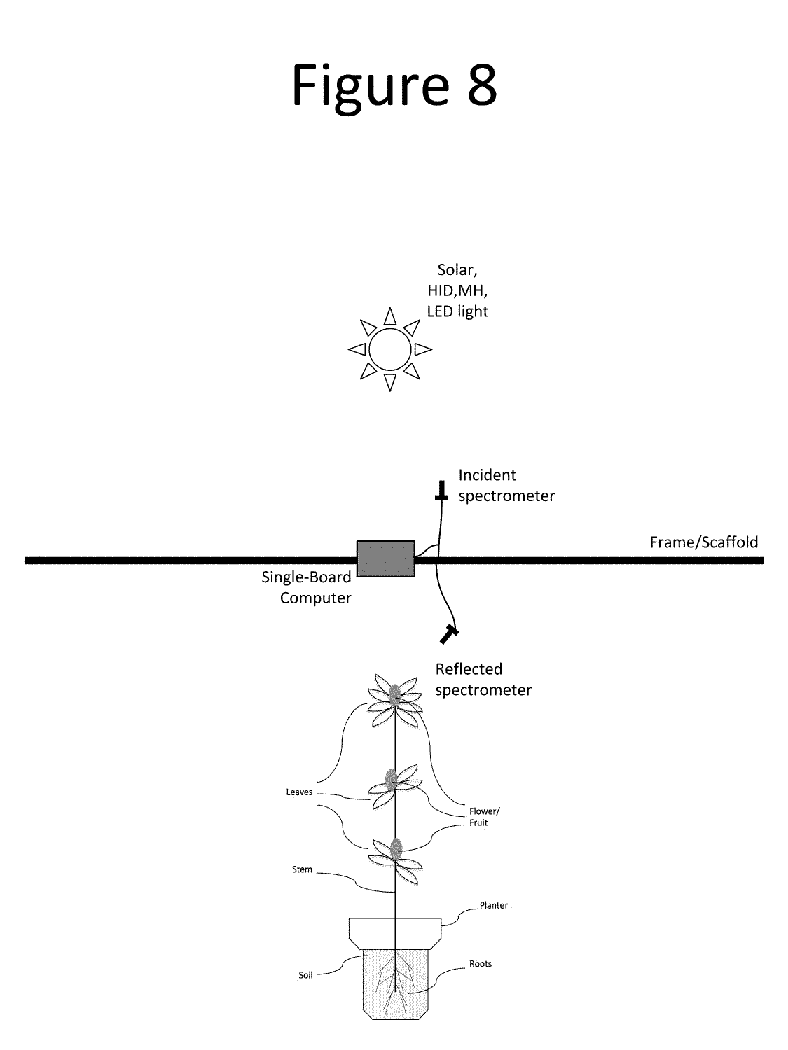

FIG. 9 is an exemplary multi-sensor installation, including a persistent spectral reflectance sensor, near-IR imager, ChFl detector and imager. A soil and environmental sensor unit also transmits measurements to a cloud database for optimization of lighting and environmental control. Grow lighting energy is provided by a High Intensity Discharge or Metal Halide grow light. Near-IR and ChFl imagers share a set of cameras and stimulus LEDs. Sensors are supported mechanically by arms that carry electrical signals and can be bent into a conformation that remains permanent.

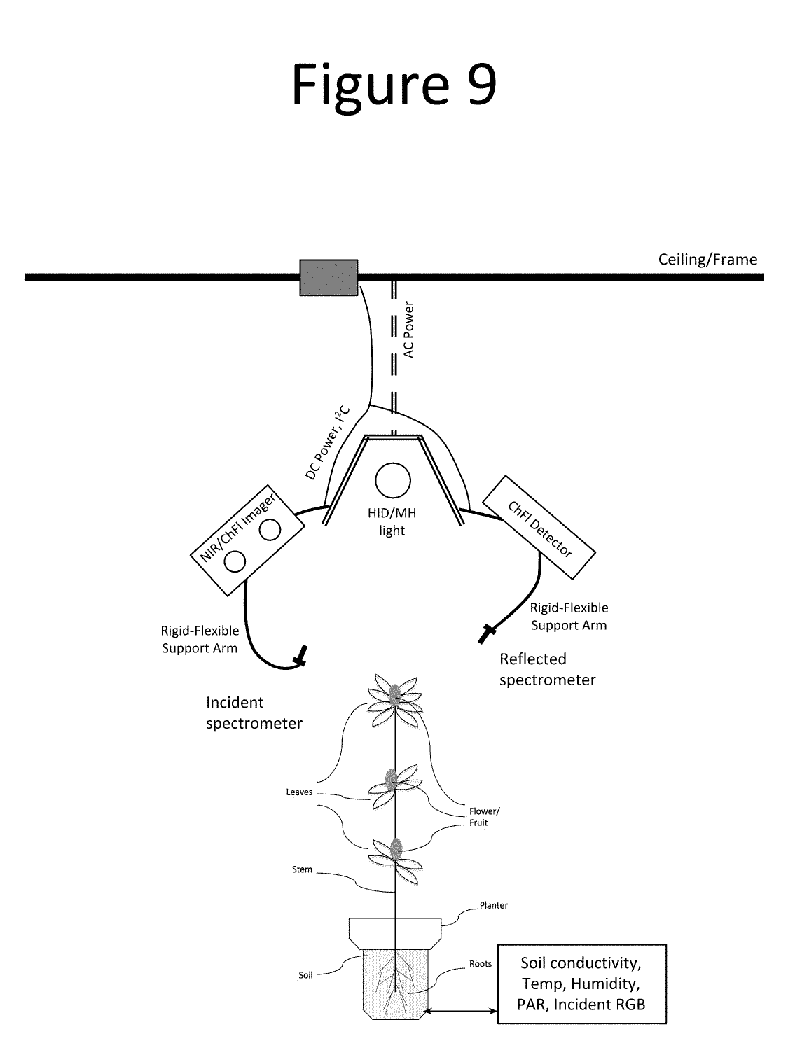

FIG. 10 is an exemplary installation of an LED grow light integrated with a spectral reflectance sensor, near-IR imager, and ChFl detector and imager. A soil and environmental sensor unit also transmits measurements to a cloud database for optimization of lighting and environmental control. Stimulus and response ChFl signals are shown.

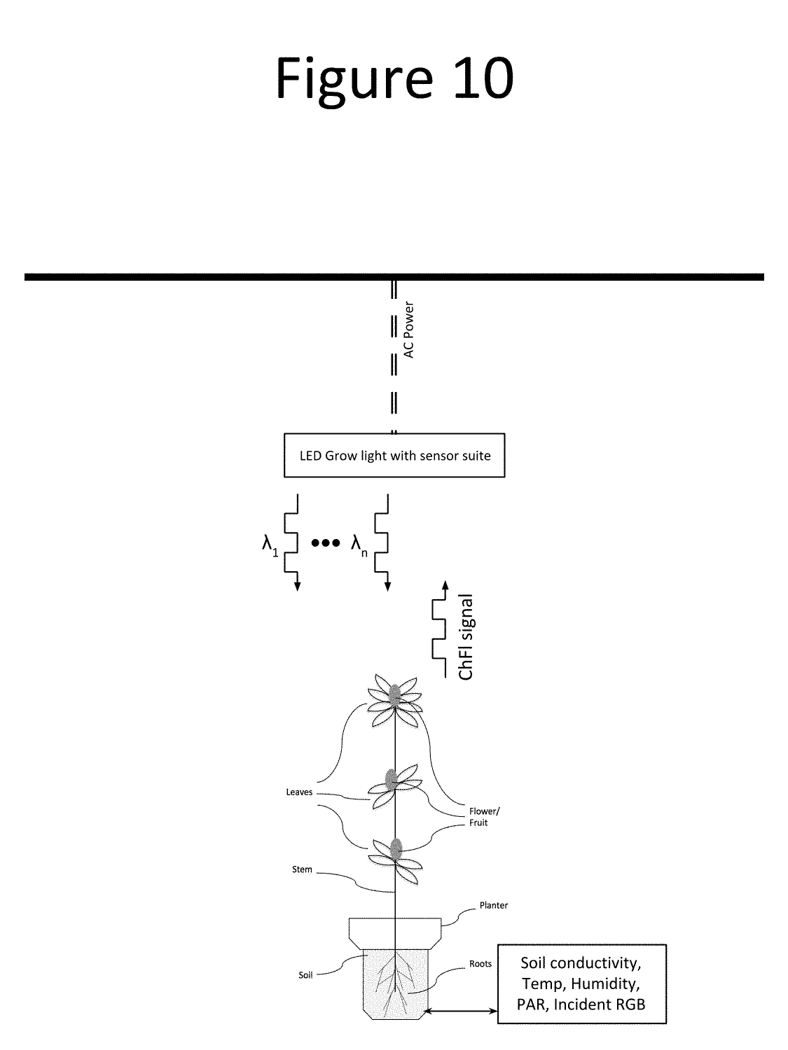

FIG. 11 is an exemplary manifestation of leaf subsystem electronics. A temperature sensor remotely measures the temperature of the leaf by sensing its infrared emissions, and also the local temperature of the sensor itself. A driver circuit receives control signals from the basestation and drives an LED for optical stimulus. A spectrometer senses the optical spectrum of the leaf. Conductors connected to the basestation relay analog and digital signals bidirectionally, as well as power for the sensors and LEDs.

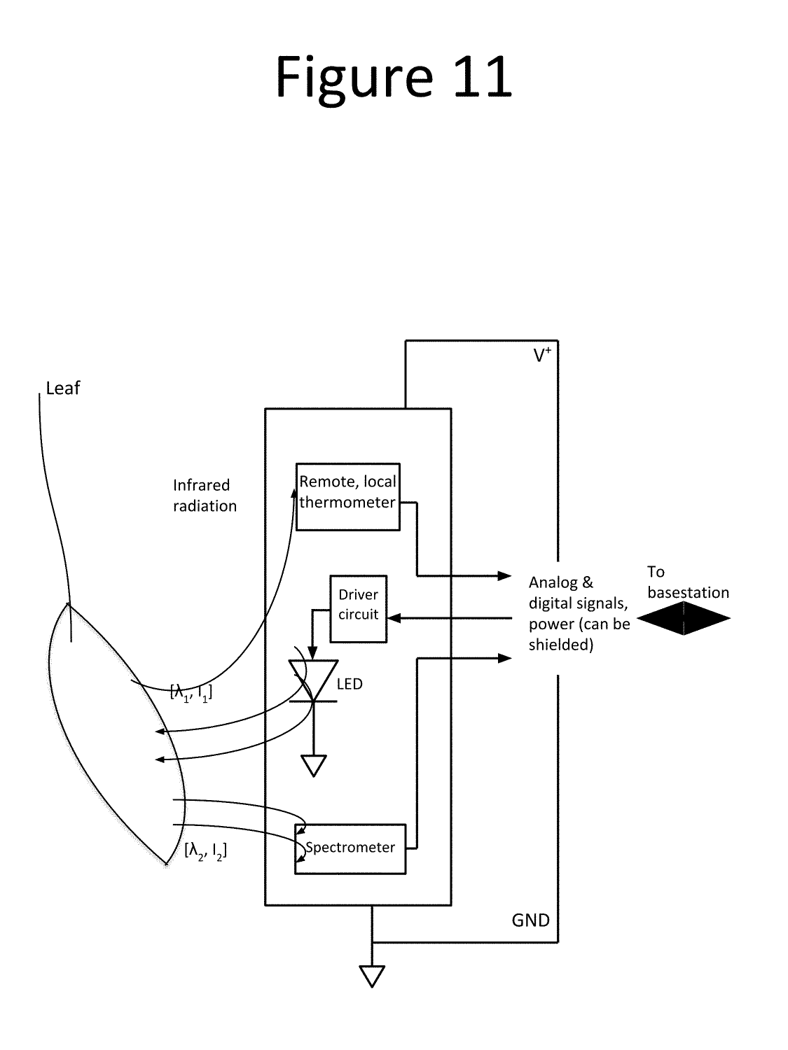

FIG. 12 is an exemplary manifestation of the flower/fruit subsystem electronics is shown. A temperature sensor remotely measures the temperature of the leaf by sensing its infrared emissions and also the local temperature of the sensor itself. Spectrometers sense the optical spectrum of the leaf. Conductors connected to the basestation relay analog and digital signals bidirectionally, as well as power for the sensors and LEDs.

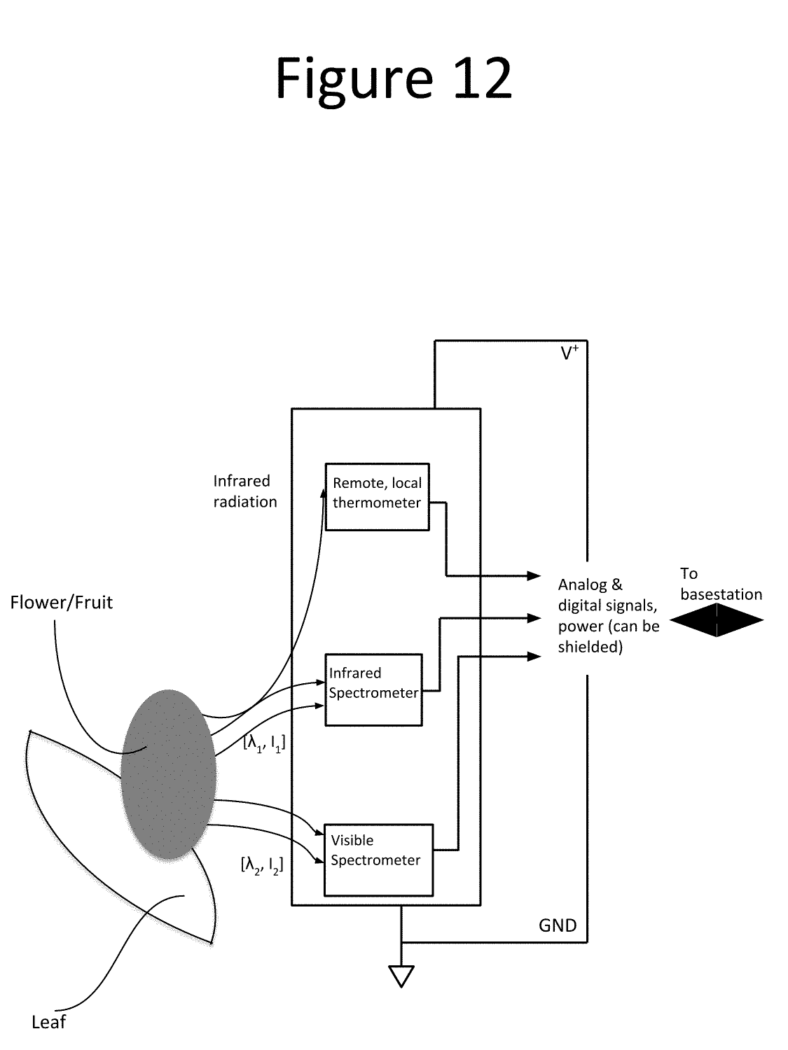

FIG. 13 provides a functional description of a ChFl emitter and detector. Pulses of light at various wavelengths are emitted towards the plant by the bank of LED emitters. The plant emits ChFl light pulses back at longer wavelength. Equations describing the various incident and ChFl light pulses are provided. An equation for the voltage sensed by the detector is given as a function of time and photon wavelength.

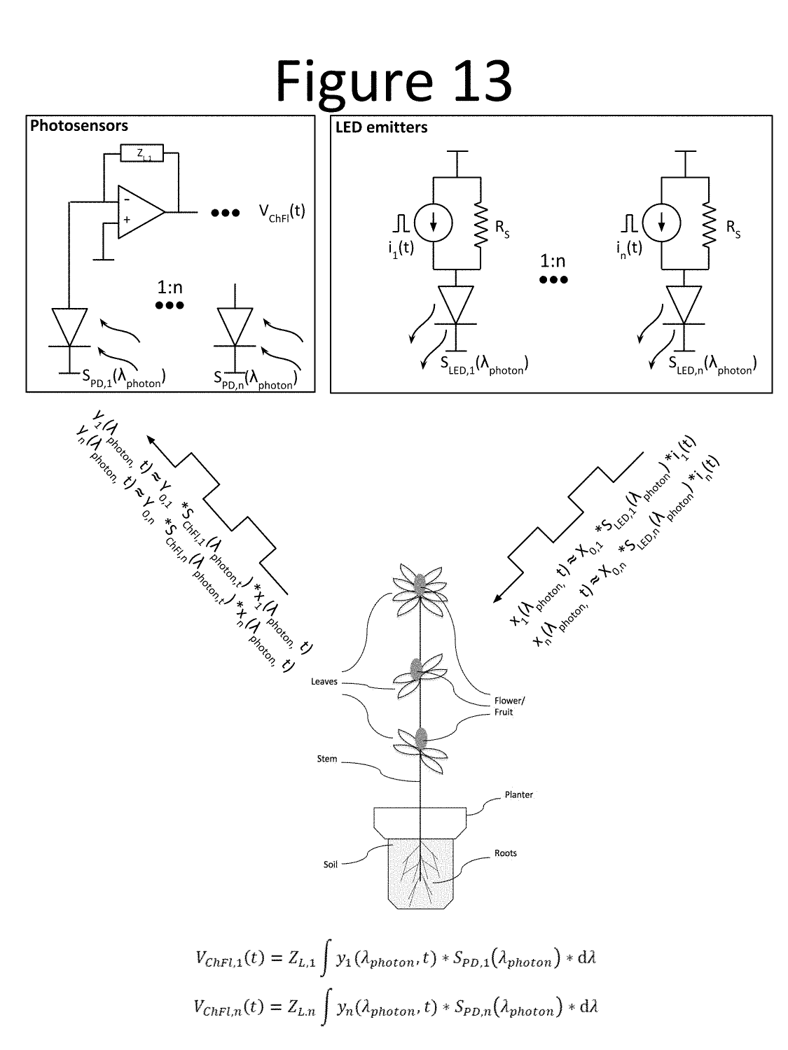

FIG. 14 shows one manifestation of system electronics for a persistent, cloud-connected ChFl detector.

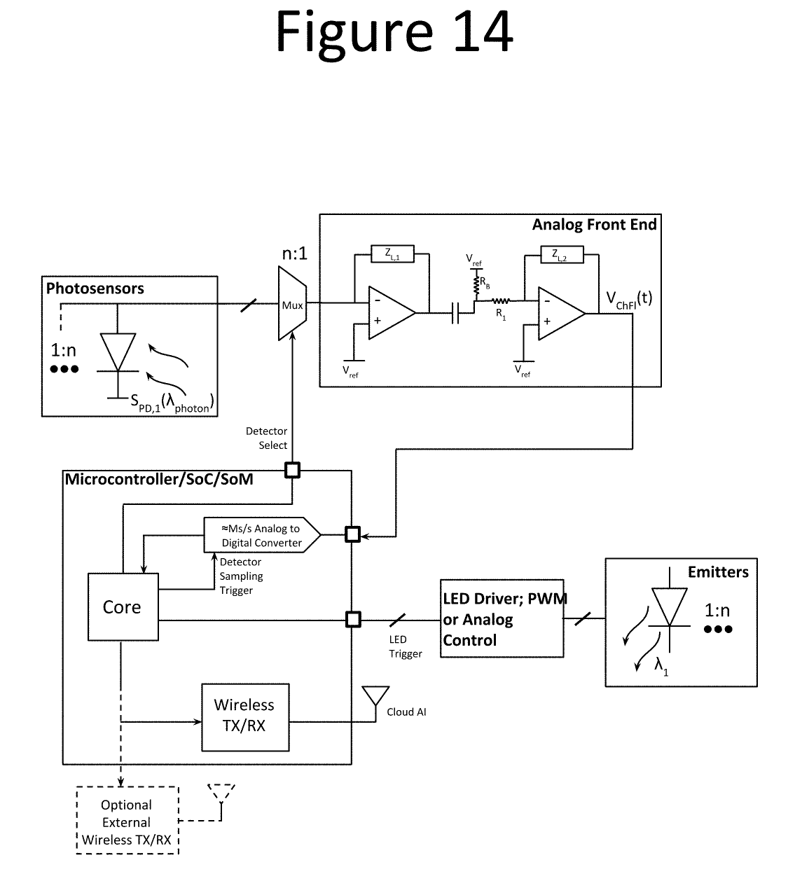

FIG. 15 provides a functional description of a two-camera near-IR imager system. Two cameras are used with different spectral responses. A near-IR emitter provides light to illuminate the scene for near-IR imaging.

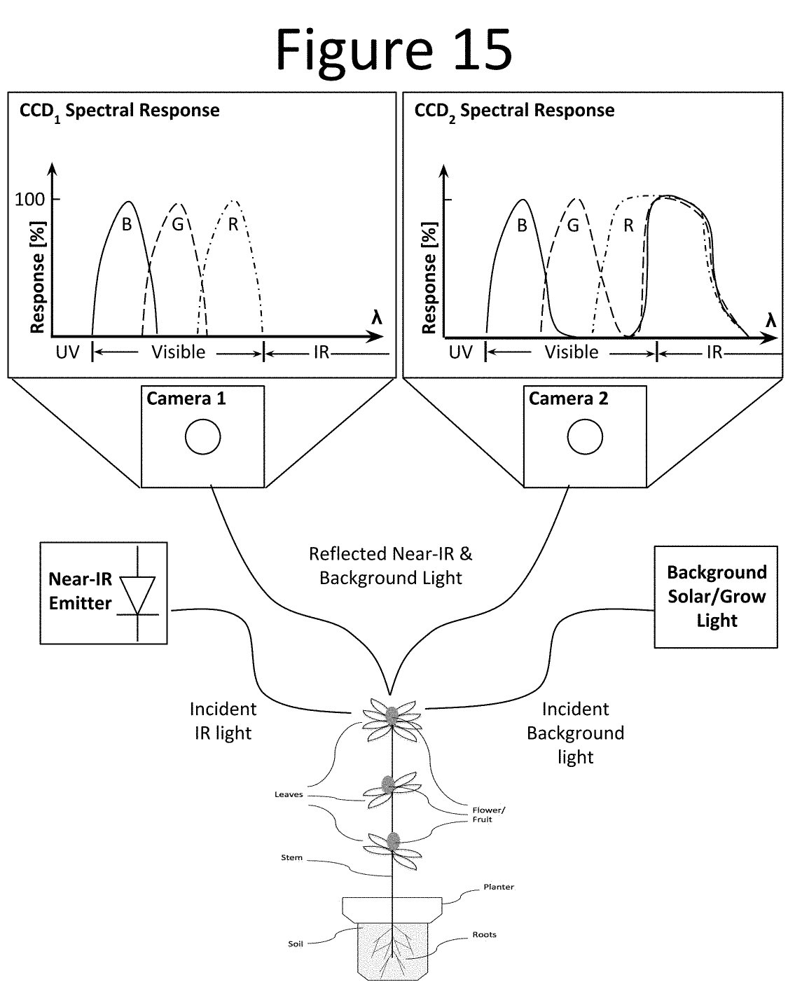

FIG. 16 provides a functional description of a two-camera near-IR imager system. Images from the two cameras with different spectral responses are sampled by a single-board computer. Image processing algorithms are used to combine both images and create an image of the near-IR band. The approximate spectral response of the resulting near-IR image is provided.

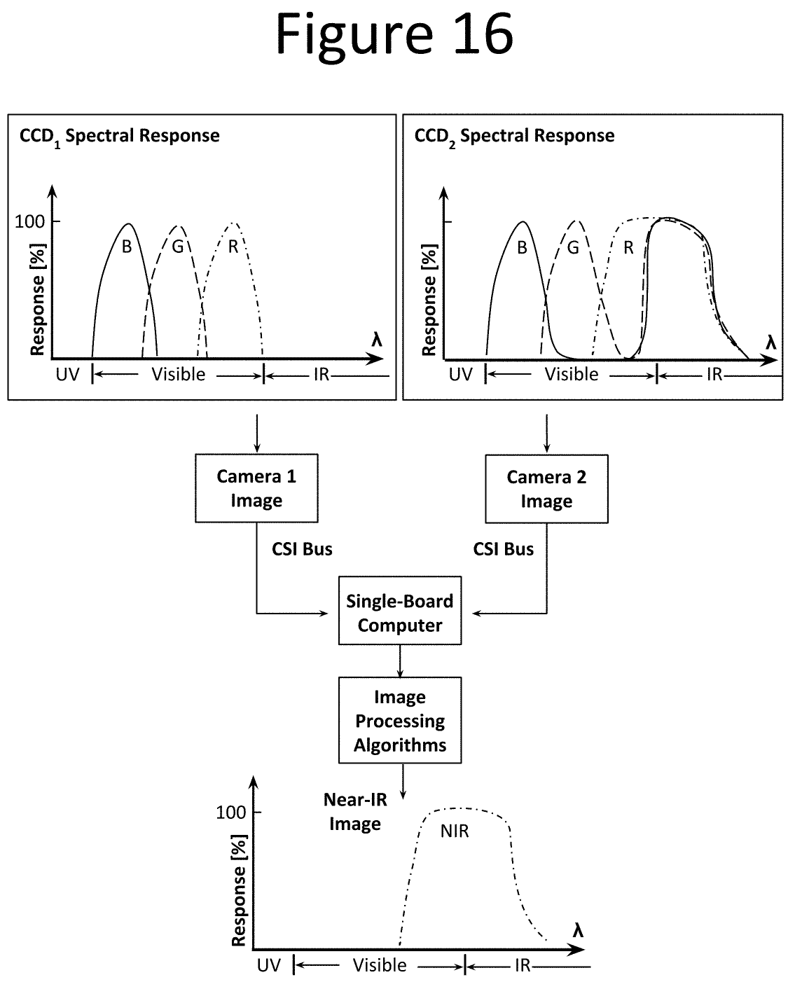

FIG. 17 provides a functional description of a two-camera ChFl imager system. Images are taken before and after application of a ChFl-inducing stimulus light pulse in the Ultraviolet (UV) waveband. Optical spectra are shown for both images. After image differencing, the resulting effective spectrum is shown. The resulting image contains only the scene's ChFl response to the applied UV pulse. Discrimination between stimulus and ChFl response signals is achieved by the native optical response of the CCD's optical filters. Separate ChFl responses can be measured at different wavelengths, falling in the B,G bands of CCD1, and the near-IR image acquired by using the near-IR imager described herein.

FIG. 18 provides a functional description of a two-camera ChFl imager system. Images are taken before and after application of a ChFl-inducing stimulus light pulse in the blue waveband. Optical spectra are shown for both images. After image differencing, the resulting effective spectrum is shown. The resulting image contains only the scene's ChFl response to the applied blue pulse. Discrimination between stimulus and ChFl response signals is achieved by the optical response of the near-IR imager described herein.

FIG. 19 is a manifestation of an LED grow light with various wavelengths of emission, and an integrated sensor suite. This integration enables the closed-loop control of lighting intensity and spectral balance, based on the real-time in-vivo optical characterization of a plant. The different wavelength LEDs can be controlled independently. The LEDs serve multiple purposes: providing energy to grow a plant, illumination for near-IR imager, as well as modulation to enable ChFl measurement and imaging.

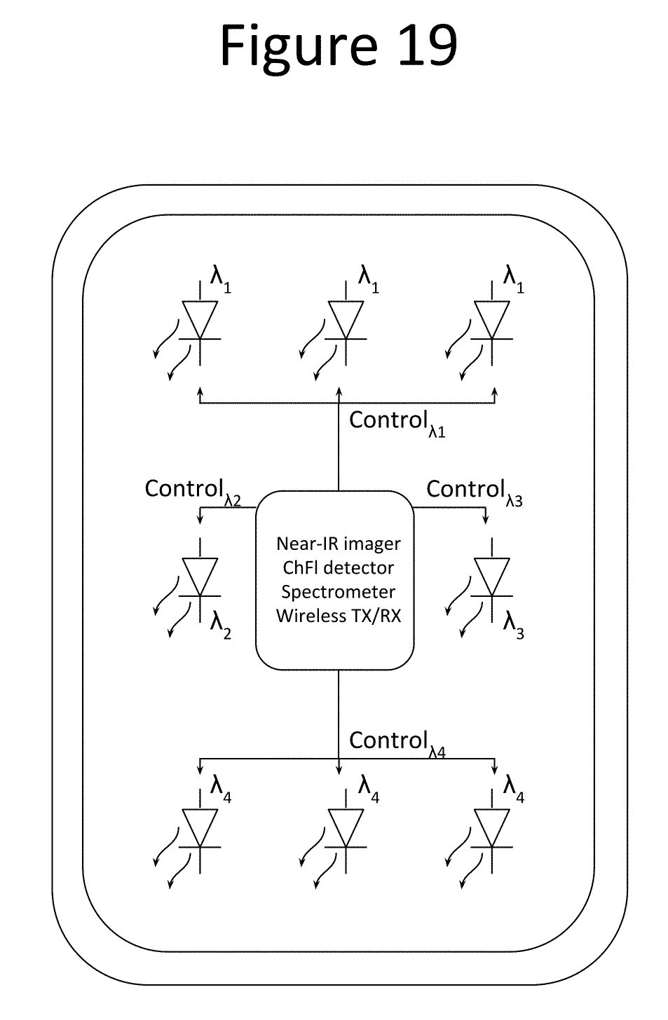

FIG. 20 presents an exemplary manifestation of the system-level electronics for the integrated sensor suite of FIG. 19.

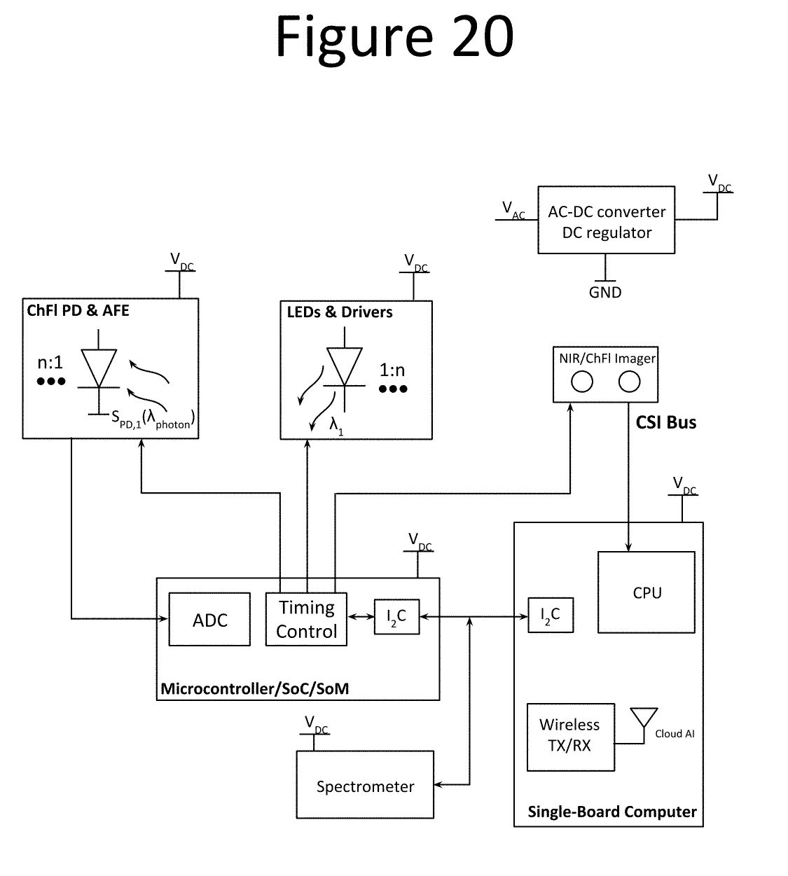

FIG. 21 provides an overview of the various sensor technologies described herein, and the overall processing of the data. Sensor data can have some local processing if applicable and is uploaded to a cloud server with a database. The cloud server can have compute instances, image processing, modeling, grow environment optimization, and other Artificial Intelligence (AI) engines.

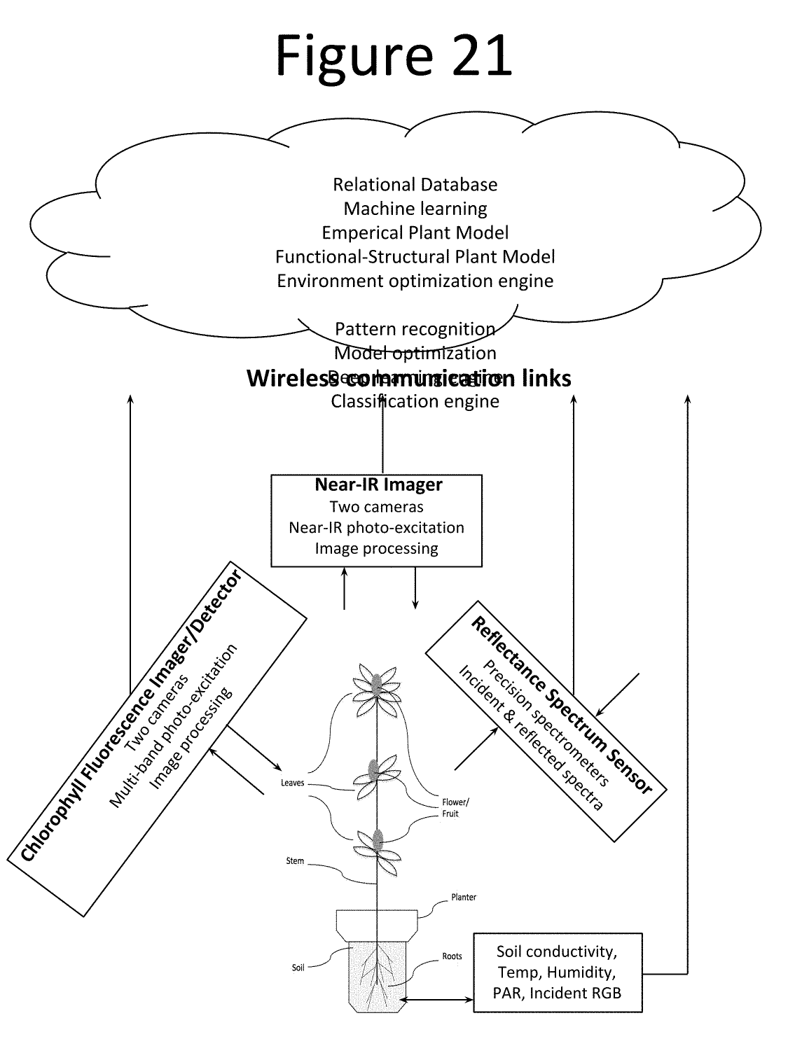

FIG. 22 shows a manifestation of an image processing pipeline, operating on near-IR images, ChFl images, as well as typical RGB images. Machine vision algorithms are used to quantify statistics about each image, and the statistics are stored in a relational database. All images also go are processed by deep learning algorithms to classify the images into various categories. Image classifications are stored in a relational database.

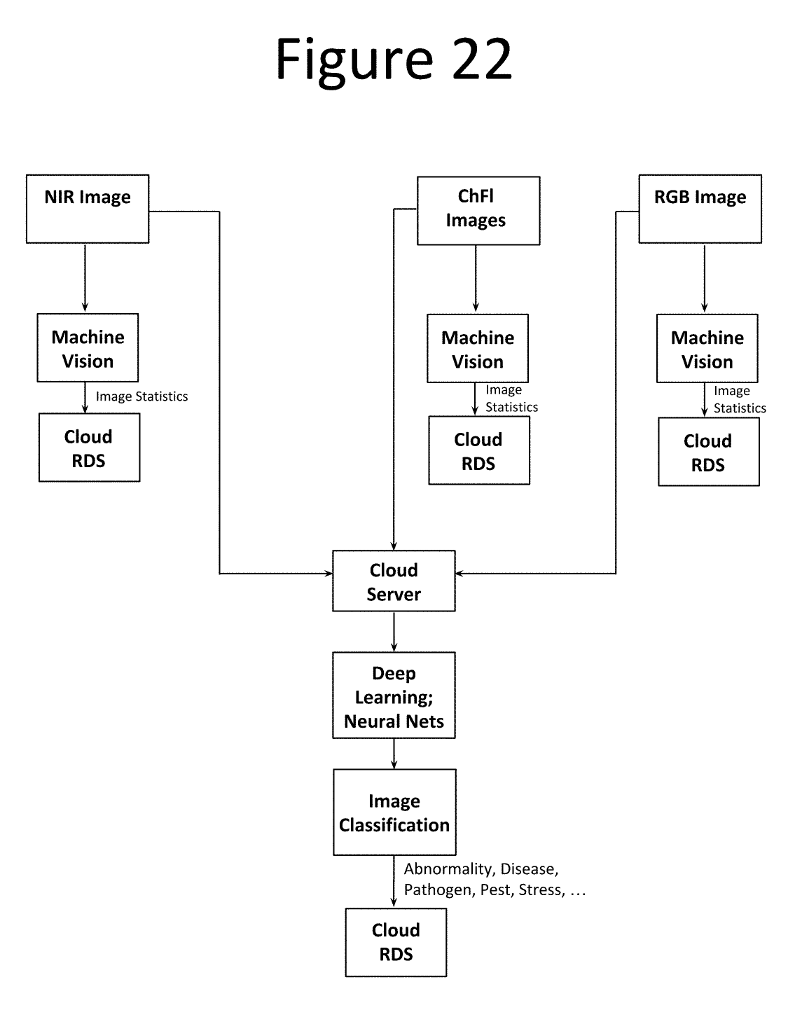

### DISCUSSION OF THE PREFERRED EMBODIMENTS

One manifestation of the present invention is a cloud-connected chlorophyll fluorescence sensor for persistent in-vivo plant heath monitoring method and system for long-term monitoring of a plant's Chlorophyll Fluorescence (ChFl) activity, with a cloud AI backend for tracking and identifying signatures in the data. This enables the persistent monitoring of plant photosynthesis as environmental conditions change. The system contains a number of LEDs that emit photons at various wavelengths to stimulate a plant's ChFl. Stimulation wavelengths can include: UV (250-400 nm), blue (400-475 nm), red (625-700 nm). To measure the ChFl signal in the presence of background lighting, the light emitters can be driven with an AC signal at kHz-MHz frequencies. The LEDs can be controlled by a microcontroller and driven by a dedicated integrated circuit capable of delivering pulses of high current.

The system also includes a number of photodetectors with varying spectral sensitivities. Optical-domain discrimination between stimulation and detection waveforms can be accomplished with careful spectral engineering of the emitters and detectors. The detector circuitry can include a low-pass or band-pass response in the analog or digital domain to isolate the ChFl signal from the background lighting. An opamp-based transimpedance amplifier can be used to interface with the detector photodiode, providing a current-voltage gain and possibly some filtering. The transimpedance amplifier can be followed by a second opamp-based gain stage to further amplify and filter the signal before digitization. A fast-sampling Analog-Digital Converter (ADC) is used to sample the detector signals at kS/s-MS/s rate and capture the insight-rich millisecond-microsecond transients in the ChFl signal. Synchronous timing between emitter and detector is critical to capture the onset and decay of the ChFl signal in response to a fast change in the stimulus signal.

The ChFl sensor system can be placed in various localities with respect to the plant. For leaf or flower/fruit-specific ChFl measurements, the sensor can be placed directly in the vicinity of the desired target. For a plant or canopy-scale ChFl measurement, the sensor can be placed at some distance above the canopy. This approach is atypical, in that ChFl measurements are typically made directly on a small section of a leaf. With the ChFl measurement data uploaded to a cloud server, it can be complemented with other macro-scale observations of the plant, e.g. reflectance spectrum and near-IR image. This data can be combined in machine learning algorithms to help identify valuable signatures in the macro-scale ChFl data.

In one manifestation of the sensor, a microcontroller is used to accurately control the timing of an LED driver integrated circuit with and a fast-sampling ADC detector. Samples can be spaced logarithmically in time to get samples across orders of magnitude in timescale, e.g. 10⁻⁶ seconds to 1 second. This enables the ChFl signal to be tracked at various timescales, while minimizing the amount of data sampled. Digital Signal Processing (DSP) can be implemented on the microcontroller, and/or on another local or cloud server. Local DSP on the microcontroller can have the advantage of reducing the size of the ChFl data. The microcontroller communicates with a wireless transceiver over a digital bus, such as I²C or SPI. A single-board computer can be used to provide the I²C interface to the microcontroller, as well as wireless connectivity. Various technologies for wireless communication can be used, including Wi-Fi, Bluetooth, Zigbee, 802.15.4, LoRa, or others.

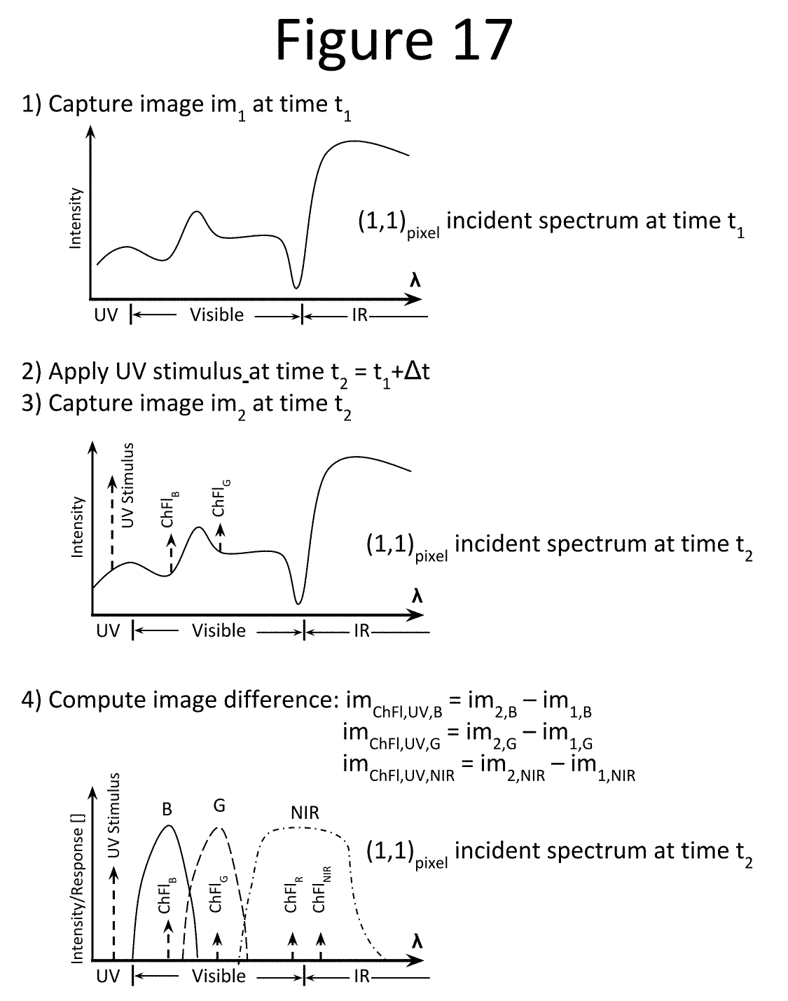

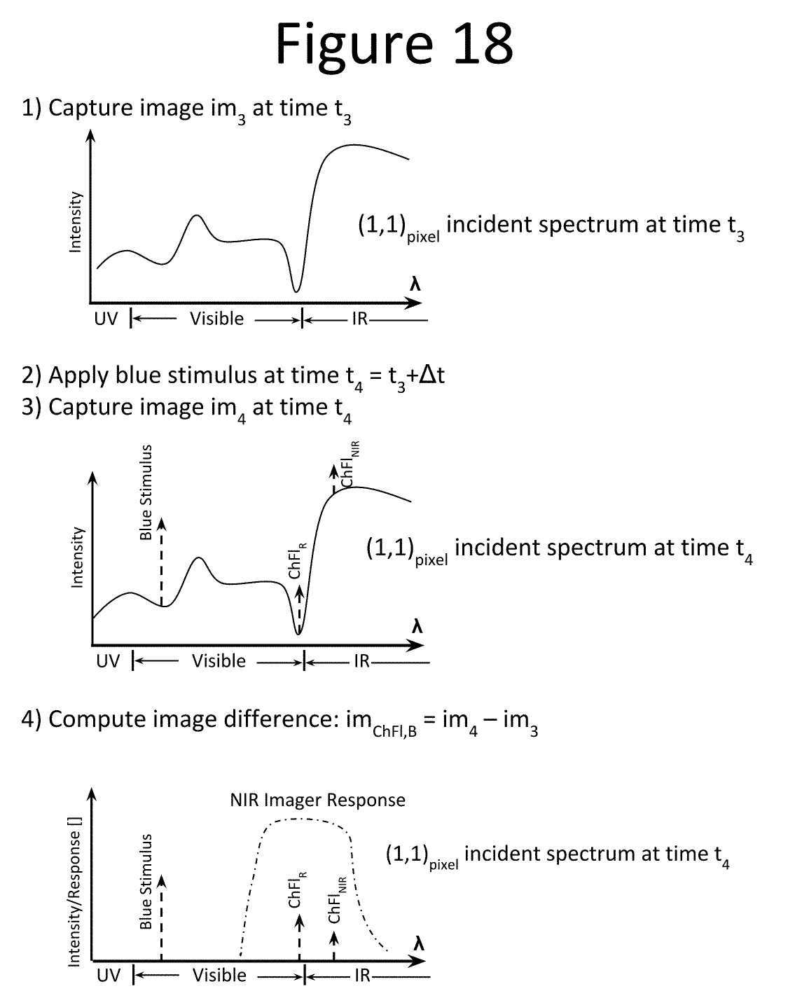

The ChFl LED emitter system can be combined with the near-IR imager described herein to provide spatial imaging of ChFl activity. This technique is described in FIGS. 17 and 18. Near-IR and RGB images are taken at two point spaced closely in time. Between the two image acquisitions, the ChFl stimulus light is applied. The difference between the two images then contains the response of the scene to the applied ChFl pulse, assuming nothing else has changed. Mock spectra incident on a single, specific pixel is shown in FIGS. 17 and 18 for each step of the image manipulation. The same process applies to each pixel in the image, but the spectra will vary from pixel to pixel. Discrimination between ChFl drive and sense signals is provided by the effective four-band imaging capability: R, G, B, NIR. For ChFl stimulus in the UV waveband, the R, G, B, NIR imager channels are not responsive to the applied UV stimulus, and the ChFl response can be read from all channels. With ChFl stimulus in the blue waveband, ChFl response activity can be read from the R, NIR imager channels.

In another manifestation of the present invention is a Low-cost near-IR imager two-camera solution for imaging the interaction of plants with light in the near-Infrared wavelength region, from approximately 700 nm to 1000 nm. This is accomplished by using two cameras co-located in space, with each having a different spectral response to incident light. One of the cameras has a detectable response that extends past the visible red region to capture longer wavelength photons in the near-IR spectral band. The extracted near-IR image can be displayed to a user as a false-color or grayscale image for viewing with the human eye.

The cameras use a typical Charge-Coupled Device (CCD) imaging system, and output standard R,G,B values for each pixel. The two cameras are ideally identical, except for the difference in spectral response to wavelengths greater than 700 nm. However, the camera with the extended spectral response will have information from near-IR wavelengths embedded in its R,G,B outputs. This provides six unique imaged data channels of the scene. Ideally, both cameras shutter their imagers at the same point in time. The following equations approximate the output of each channel for one pixel, where I(λ) represents the incident photons, and S(λ) represents the spectral response of the respective camera channel.

∫_{600 nm}^{700 nm}I(λ)*S_{R1}(λ)dλ

R_{extended}≈∫_{600 nm}^{700 nm}I(λ)*S_{R2}(λ)dλ+∫_{700 nm}^{1000 nm}I(λ)*S_{R2}(λ)dλ

G≈∫_{450 nm}^{650 nm}I(λ)*S_{G1}(λ)dλ

G_{extended}≈∫_{450 nm}^{650 nm}I(λ)*S_{G2}(λ)dλ+∫_{700 nm}^{1000 nm}I(λ)*S_{G2}(λ)dλ

B≈∫_{400 nm}^{525 nm}I(λ)*S_{B1}(λ)dλ

B_{extended}≈∫_{400 nm}^{525 nm}I(λ)*S_{B2}(λ)dλ+∫_{700 nm}^{1000 nm}I(λ)*S_{B2}(λ)dλ

The images from each of the cameras are next manipulated by image processing algorithms in software. These algorithms function to process the six available image channels and extract an image representing only the light from the scene in the near-IR band. Ideally, both cameras can be considered to have the same geometrical view of the scene. One possible implementation that can be used to extract the near-IR band (NIR) image is the following:

NIR≈R_{extended}−R=∫_{600 nm}^{1000 nm}I(λ)*S_{R2}(λ)dλ−∫_{600 nm}^{700 nm}I(λ)*S_{R1}(λ)dλ

NIR≈∫_{700 nm}^{1000 nm}I(λ)*S_{R2}(λ)dλ

To perform imaging in the near-IR band, there must be a source of light to illuminate the scene in the target imaging wavelengths. This is required, as the imager is effectively quantifying the light reflected from objects in the scene. The IR light can come from background irradiation (e.g. solar light), or from an additional IR light source dedicated to illuminating the scene for imaging purposes.

The near-IR imager can be placed above a plant canopy, possibly adjacent to a grow light. This provides the imager with a top-down view of the canopy, and a clear view of the plant's leaves. The near-IR images can be used to identify abnormalities in the plant matter, for example, “hot” or “cold” spots on the leaves. These images can potentially provide advanced detection of disease or stress, such as pathogens, mold, mildew, pests, nutrient imbalance, etc. The near-IR imager can also be placed elsewhere to have a wider, canopy-scale view. This has the potential to identify possible farm-scale abnormalities, for example, non-uniform lighting, heating or cooling, humidity, CO2 level, etc.

In one manifestation of the system, the two cameras connect to a single-board computer, for example, a Raspberry Pi, over a CSI bus. The single board computer can be programmed to sample the cameras at specified intervals. The system also includes a transceiver for wireless communication, which can be an integrated component of the single board computer. Various technologies for wireless communication can be used, including Wi-Fi, Bluetooth, Zigbee, 802.15.4, LoRa, or others. Image processing can take place locally on a single board computer or Graphics Processing Unit (GPU), or network server. The images can also be uploaded to a cloud compute instance for remote image processing, viewing, or storage.

In a third manifestation of the present invention is a cloud-connected, persistent spectral reflectance sensor for persistent in-vivo plant heath monitoring compact system and method for long-term, precise tracking of plant optical reflectance and/or absorbance spectrum. The system is cloud-connected, enabling data from the deployed sensor to be acquired persistently without intervention, and viewed remotely. The measured spectra data is monitored by AI algorithms over time to identify spectral signatures indicative of underlying plant physiological function.

To measure the reflectance spectrum of a surface, two quantities must be known: the spectrum of the light incident on the surface, as well as the spectrum of the light reflected from the surface. This can be seen by the following equation, where p(λ) is the reflectance, I(λ) is the spectrum of light incident on the surface, and R(λ) is the light spectrum reflected from the surface:

$$ρ ( λ ) \approx \frac{R ( λ )}{I ( λ )}$$

The incident and reflected spectrum can be measured with precision spectrometers. Ideally, a spectrometer has very precise resolution in the light wavelength domain, precise measurement of incident power at each wavelength, measures a wide range of wavelengths, and can be sampled at a fast rate. Spectrometers have been commercially available and used in agriculture for years. However, they are typically bulky and expensive. Innovation in electronics, nanofabrication and sensor technology have enabled new spectrometer devices that are smaller and more cost-effective, enabling new levels of integration. Evolving technology has produced spectrometers that are capable of approximately 1-5 nm wavelength resolution spanning the visible and near-IR bands, in a roughly cubic inch-scale, and sub-$100 cost.

In one manifestation of the system, two spectrometers are connected to a single-board computer, e.g. Raspberry Pi, over a USB cable or an I2C bus. In another manifestation, the spectrometers are connected to a microcontroller via an I2C bus. The single-board computer or microcontroller controls the sampling of the spectrometers at a desired interval. The system also includes a transceiver for wireless communication, which can be an integrated component of the single board computer. Various technologies for wireless communication can be used, including Wi-Fi, Bluetooth, Zigbee, 802.15.4, LoRa, or others. The two spectrometers can also be separately connected to two different single-board computers or microcontrollers, with two separate wireless transceivers. In this case, the incident and reflected spectra data can be combined and analyzed downstream, e.g. in the cloud.

The spectrometers can be co-located, for example, on a printed circuit board, with the spectrometers on opposite sides of the substrate to detect both incident and reflected spectra. They can also be placed in different locations. A preferred place for the incident spectrometer would be at canopy-height, facing up towards the incident light source. The spectrometer measuring the reflected signal can be placed specifically adjacent to a desired part of the monitored plant, e.g. the leaves or flower/fruit. Since the spectrometer does not provide any spatial information, its physical location can provide additional specificity in its output data

In a fourth manifestation of the present invention, an Optical sensor integrated LED grow light for closed-loop spectral control multi-sensor system integrates the sensors with an LED grow light. The grow light can contain LEDs that emit at a number of different wavelengths, such as UV, blue, red, and near-IR, and can be controlled independently. These LEDs can serve dual purposes: providing energy for the plants to grow, as well as being used for the various sensor systems. The near-IR LEDs can be used to illuminate the scene for the near-IR imager. The UV, blue, and red LEDs can be intelligently pulsed to stimulate Chlorophyll Fluorescence, which can then be sensed by an integrated ChFl detector. The spectrum emitted by the LED grow light can be quantified during manufacturing, as a function of the set intensities of each LED channel. Its output spectrum is then known during the grow light's use. This eliminates one required spectrometer that would otherwise be used to sense the light spectrum incident on the plant, reducing the cost of the system.

The direct integration of the sensing system with LED lighting enables the real-time adjustment of the light properties based on sensor data, in one self-contained system. This effectively creates a closed-loop feedback system that is capable of reading the plant's acclimation to its lighting and optimizing it in real-time. A calibration routine can be run at specified intervals that sweeps the intensity and spectrum of the lighting across a defined parameter space, while simultaneously sampling some or all of the sensor systems. This can provide a comprehensive set of data that can be used to find an optimal lighting condition.

This integrated system is beneficial to farms of all sizes. The lighting output is custom-tailored to the plants growing under each light. This provides custom lighting conditions that are optimized and can vary across the farm. The system is easily scalable, and is ideally combined with data from other sensors to better understand the plants' health status. The additional sensors can include, but are not limited to: temperature, Photosynthetically Active Radiation (PAR), Hygrometer, CO2 level, soil electrical conductivity, soil suspended solids, soil pH, leaf temperature via IR thermometer, soil tensiometer, Volatile Organic Compound (VOC) sensor, and air particulate matter.

In each of the preferred embodiments above, measurements from the described sensors can be transmitted over the internet and stored in a cloud database, for example PostgreSQL RDS on Amazon Web Services and the systems optimized via artificial intelligence (“AI”) and machine learning optimization engine. Here, the measurements can be combined for a fuller description of the plant's health and condition. Over time, this generates a large multi-dimensional dataset that can be fed into machine learning. The sensors described in this invention have the capability to non-invasively monitor photosynthetic efficiency as various environmental parameters change. Machine learning techniques can be deployed that find relationships between the plant's photosynthetic throughput, and all other measured parameters. Linear and non-linear relationships can be explored and quantified with Partial Least Squares (PLS) regression or manifold learning techniques, respectively. A physical-based model, for example a structural-functional plant model or leaf optical model, can also be adapted to measurement data and be used for predictions. The sensor and AI system can also be used for identifying specific plants that have advantageous traits such as improved stress resilience or environmental acclimation.

After a model is built from an appropriate amount of training data, the AI can provide farmers with recommended optimizations to improve the plant's health and operational status. Other dependent variables can also be modeled and optimized. As measurements are obtained across a range of conditions, an ideal target process recipe can be determined for a specific plant's genotype, phenotype, and desired trait of optimization. Farmers can also provide the software algorithms with post-harvest measurements acquired later in the processing flow, such as yield, quality, or chemical makeup. This enables the further training of AI algorithms and models to optimize processes for final deliverables.

While the present invention has been described with reference to exemplary embodiments, it is to be understood that the invention is not limited to the disclosed exemplary embodiments. The scope of the following claims is to be accorded the broadest interpretation to encompass equivalent structures and functions.

What is claimed is:

1. The invention disclosed herein.
